(19) United States
(12) Patent Application Publication
(10) Pub. No.: US 2022/0235768 A1
(43) Pub. Date: Jul. 28, 2022

(54) POSITIONING ARRANGEMENT

(71) Applicant: Hanon Systems, Daejeon (KR)

(72) Inventor: Uwe Poschenrieder, Bornheim (DE)

(21) Appl. No.: 17/596,464

(22) PCT Filed: Aug. 27, 2020
(86) PCT No.: PCT/KR2020/011481

§ 371 Date: Dec. 10, 2021

(30) Foreign Application Priority Data
Sep. 12, 2019 (DE) 10 2019 124 516.8

(51) Int. Cl. F04C 18/02

(52) U.S. Cl. CPC F04C 18/0215; F04C 2240/805; F04C 2230/603

(57) ABSTRACT

A positioning arrangement for positionally accurate connection of a basic component to a centering component for achieving axial centricity of a basic component axis and a centering component axis relative to one another, wherein at least three but no more than six positioning pins are arranged and anchored in the centering component and reach into pin holes in the basic component, forming a positive-locking connection, wherein the basic component and the centering component are connected and positioned relative to one another.

### CROSS-REFERENCE TO RELATED APPLICATIONS

This application is a United States nation phase patent application based on PCT/KR2020/011481 filed on Aug. 27, 2020, which claims the benefit of German Patent Application No. 10 2019 124 516.8 filed on Sep. 12, 2019, the entire disclosures of which are hereby incorporated herein by reference.

### TECHNICAL FIELD

The present invention relates to a positioning arrangement for positioning axially adjacent machine components or parts.

Particularly in the case of rotating components, it is important for adjacent, connected components that share a common rotary axis to exhibit minimized axial offset to one another. One potential area of application of the invention lies in the construction and installation of scroll compressors for motor vehicle air-conditioning systems.

### BACKGROUND ART

Various positioning arrangements are known from the state of the art for centering two axially connected components, where technically relevant elements such as bearing seats need to be aligned precisely with one another. This is often performed by pairing two pins, which are inserted and fixed in a borehole in one of the two parts, as well as two corresponding boreholes in the second part for accepting these pins. These pins are also referred to as positioning pins and the corresponding boreholes as pin holes. During installation, the component with the projecting positioning pins is connected to the component with the pin holes in a kind of plug-in connection. The positioning pins produce a positive-locking connection when inserted into the pin holes here. The positioning accuracy is dependent on the tolerances used when manufacturing and fixing the pins in place in a component, as well as the positioning of the corresponding pin holes.

Another embodiment of positioning arrangements is based on the principle of positioning studs and corresponding stud holes. This is, for example, implemented by mating a projecting central n stud, which is machined into a component and exhibits a diameter close to the external dimensions of the component, with a central cylindrical recess of approximately the same diameter in the component to be axially connected.

Both aforementioned concepts are subject to a certain joint clearance due to a slight nominal difference in diameter, which then gradually contributes to positioning errors following installation.

The concepts as per the state of the art suffer from a disadvantage, as they are subject to limitations in terms of the manufacturing precision that can be achieved when producing the positioning arrangement, which in turn generally limits the centering precision that can be achieved.

### SUMMARY

The object of the invention lies in providing a positioning arrangement that allows the positioning accuracy to be improved without increasing demands in terms of its manufacturing precision. The objective here is to achieve minimized axial offset for axially adjacent machine components through use of the positioning arrangement.

The task is solved by a device that exhibits the characteristics as shown and described herein.

The object of the invention is, in particular, resolved with a positioning arrangement for positionally accurate connection of a basic component to a centering component in order to achieve axial concentricity, wherein the basic component exhibits a basic component axis and the centering component exhibits a centering component axis, which are to be arranged with minimum axial offset and thereby the greatest possible axial concentricity. It has been shown that increased positioning accuracy can be achieved by arranging and anchoring at least three but no more than six positioning pins in the centering component which are then inserted into pin holes in the basic component and thereby create a positive-locking and positioning fit when a connection is established between the basic component and the centering component.

The object of the invention is preferably resolved by a positioning arrangement, wherein this arrangement is produced with precisely five positioning pins in the centering component and five corresponding pin holes in the basic component.

The positioning pins are advantageously arranged around the centering axis with equal spacing to the centering axis.

The positioning pins are particularly advantageously arranged such that they are spread across the perimeter of a circle around the centering axis, i.e. distributed with equal spacing.

As an alternative to this, the positioning arrangement is advantageously produced by the positioning pins being randomly distributed around the centering axis.

The positioning of two components by the positioning arrangement described above is advantageously increased by additionally producing a central cylindrical stud in the centering component and central cylindrical recess in the basic component.

The positioning pins are advantageously produced from steel and anchored in the centering component, itself produced from aluminum.

One advantageous embodiment of the invention lies in optimizing a scroll compressor with fixed scroll and orbiting scroll such that the fixed scroll with five positioning pins is arranged in axial concentricity with the compressor shaft in the compressor housing. Alternatively, the positioning pins are arranged on the scroll.

The conceptual design of the invention is therefore based on duplication of the individual immanent positioning and dimensional errors of the individual positioning elements known from the state of the art that are locked together simultaneously in order to reduce the positioning errors of the component axes of the connected components.

This in turn is based on the fact that positioning concepts with limited centering precision for functional axes result in periodic relative compensatory movements of individual elements of multi-piece rotors if these execute different path movements as a result of corresponding mechanical guidance. For example, the drive shafts of the entire rotor assembly rotate in a scroll compressor. The compressor scroll driven by the shaft via the coupling stud and an interconnected coupling element, the orbiting scroll, executes a circular path movement. The radius of the circular path that it tracks is guaranteed by continuous radial running against the fixed compressor scroll, the fixed scroll. If the geometric axis of the fixed scroll is radially offset from the shaft axis, this generates additional relative movements and thereby excites rotor and guide elements. These in turn lead to additional component stresses and also contribute to a worsening of the operating noise. The NVH characteristics in motor vehicles then generally deteriorate. NVH stands for noise, vibration and harshness. It is used to describe the audible or perceivable vibrations in motor vehicles or on machines.

Using the positioning arrangement according to the invention enables more precise centering of component axes and thereby more precise guidance of rotor components. This results in lower deviation from functionally stipulated path movements of guided rotor elements, which reduces excitement due to path deviations of individual elements of coupled rotors, in which various components are responsible for guiding the path of individual rotor elements.

The fact that positioning accuracy is significantly increased with minimal additional effort thanks to additional positioning pins and corresponding recesses is particularly advantageous here. This can be achieved simply by increasing the number of tried-and-tested small positioning pins, which themselves are affordable to produce.

The various requirements in terms of equipment robustness, as well as the requirements of low operating noise of the equipment, can be met through use of improved path guidance of rotor elements, which is achieved by increasing axial concentricity.

Added to this is the fact that improved path guidance of rotor elements leads to both reduced mechanical excitement and reduced additional stress of the components, which is a top priority in the requirements profile of users and actually comparable with fulfilment of the primary functions of the compressor, such its delivery capacity, overall efficiency and efficiency.

### BRIEF DESCRIPTION OF DRAWINGS

Further details, features and benefits of embodiments of the invention result from the following description of embodiment examples with reference to the accompanying drawings. These display the following:

FIG. 1: Positioning arrangement using positioning studs as per the state of the art,

FIG. 2: Positioning arrangement using positioning pins as per the state of the art,

FIG. 3: Positioning arrangement with two positioning pins,

FIG. 4: Positioning arrangement with five evenly distributed positioning pins,

FIG. 5: Positioning arrangement with five unevenly and randomly distributed positioning pins,

FIG. 6: Positioning arrangement with uneven distribution of the positioning pins in rows,

FIG. 7: Diagram of axial offset in the form of relative axial offset as a function of the positioning pins via the number of positioning pins,

FIG. 8: Diagram of the relative reduction in axial offset achieved by increasing the number of positioning pins,

FIG. 9: Diagram of the relative radial offset when using two positioning pins,

FIG. 10: Diagram of the relative radial offset when using five positioning pins,

FIGS. 11A and 11B: Positioning arrangement for scroll compressors with two positioning pins and

FIGS. 12A and 12B: Positioning arrangement for scroll compressors with five positioning pins.

### DETAILED DESCRIPTION OF AN EMBODIMENT

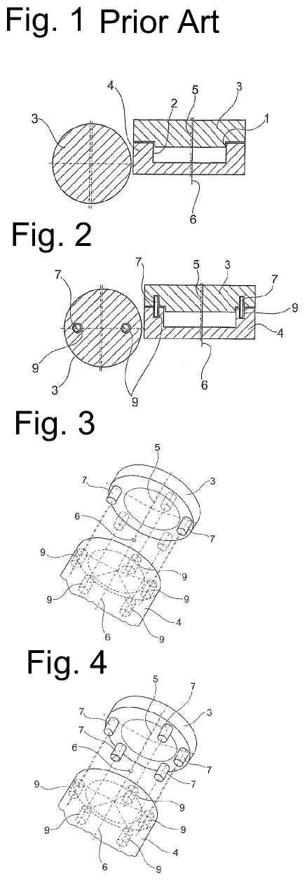

FIG. 1 shows a positioning arrangement as per the state of the art, in which a centering component 3 exhibits a central cylindrical stud 1 that engages in the central cylindrical recess 2 on a basic component 4. The central cylindrical stud 1 is produced at minimal costs as a cylindrical stud of a defined diameter. Corresponding to this, the central cylindrical recess 2 is produced in the form of a cutout or hole, into which the stud is inserted and engaged. The manufacturing tolerances for the stud and the hole result in a certain amount of play, which in turn can cause the centering component 3 in the basic component 4 to move. The centering component axis 5, shown as a broken line, exhibits an offset relative to the basic component axis 6, which is shown as a solid line. The offset of the two axes 5, 6 is also referred to as component or axial offset. The offset of the components relative to one another is shown as a broken line in the plan view of centering component 3. The axes are shown as offset by one plane relative to one another as intersecting points of the guiding lines.

FIG. 2 shows another embodiment as per the state of the art for connecting a centering component 3 to a basic component 4. Here, the positioning arrangement is extended to include positioning pins 7, which are arranged in the centering component 3 and shown opposite. The positioning pins 7 are permanently anchored in the centering component 3 here. The basic component 4 exhibits pin holes 9, produced as boreholes, into which the positioning pins 7 are inserted, thereby establishing a positive-locking and positioning connection. The positioning pins 7 are themselves preferably produced with a circular cylinder shape. As a result of the manufacturing tolerances for the positioning pins 7 and the pin holes 9, the centering component axis 5 and the basic component axis 6 are subject to an offset and thereby to reduced axial centricity of the centering component axis 5 relative to the basic component axis 6. In the plan view of the centering component 3, the offset of the positioning pins 7 in the pin holes 9 is shown as a sectional view.

FIG. 3 provides a perspective depiction of the positioning arrangement as per FIG. 2, wherein additional positioning pins are indicated, but not explicitly shown.

FIG. 4 shows the preferred embodiment according to the invention with use of a positioning arrangement with five positioning pins 7. The positioning pins 7 are recessed and fixed in the centering component 3 here. The centering component 3 has a centering component axis 5, which is produced with minimal axial offset to the basic component axis 6 with the pin holes 9 for the positioning pins 7 of the centering component 3. As per FIG. 4, the positioning elements, i.e. the positioning pins 7 that engage in the pin holes 9, are arranged equidistantly (with even spacing) around the perimeter of a circle surrounding the centering component axis 5.

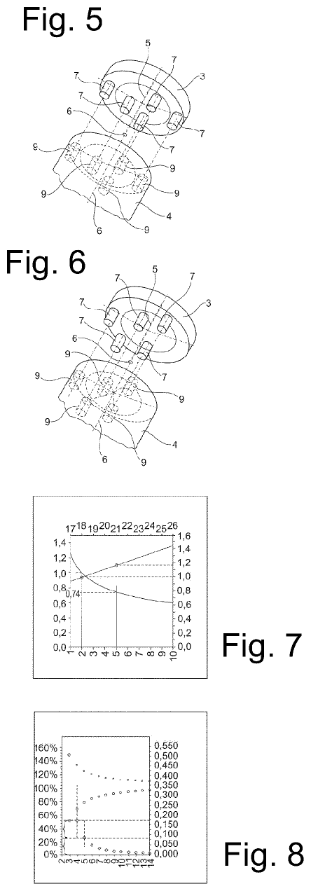

FIG. 5 shows the positioning system as a positioning arrangement with five positioning pins 7 on the centering component 3, although with uneven distribution. The uneven distribution of the positioning pins 7 and the arrangement of the pin holes 9, correspondingly distributed on the basic component 4, permits error-free angular alignment and positioning of the components relative to one another, as any twisting of the centering component 3 relative to the basic component 4 as a result of the random arrangement of the positioning elements is effectively prevented during installation.

FIG. 6 shows the positioning arrangement in an alternative embodiment with uneven distribution of the positioning pins 7 and the corresponding pin holes 9. The centering component axis 5 of the centering component 3 can be mounted with low axial offset relative to the basic component axis 6.

FIG. 7 shows a diagram that depicts the relative axial offset of the embodiment as per FIG. 3 with two positioning elements to the embodiment as per FIG. 4 with five positioning pins. The lower x-axis shows the number of positioning pins here, while the left-hand ordinate shows the average relative axial offset, referenced to the embodiment with two pins, as a function of the number of positioning pins. The additional manufacturing and installation effort is suggested on the upper x-axis by taking into account the larger number of pins. Here, the referenced average relative axial offset is shown as a function of the number of pins. The right-hand ordinate shows the ratio of the sum of all pins, including the positioning pins, and the sum of pins to date.

FIG. 8 shows the weighted effect of the additional pins. Since the improvement that can be achieved over an embodiment with two pins by increasing the number of positioning pins from four to five corresponds to or even surpasses the improvement that can be achieved through use of an “endless” number of pins in addition to the embodiment with five pins, a number of five pins is considered optimal for real-world use. On the hand, the number of positioning elements is also restricted by the installation space available inside the mechanical arrangement, which is why the number of pins must also remain limited for reasons of practicality.

The depictions show that a total reduction of around 25 percent in both the maximum axial offset to be anticipated and the average axial offset can be achieved by increasing the number of positioning elements from 2 to 5.

The x-axis shows the number of positioning pins used. The left-hand ordinate shows the reduction in relative offset, referenced to an embodiment with two pins, as well as the additional relative effort required to introduce another pin, referenced to the existing number of pins in the positioning system. The right-hand ordinate shows the relative reduction in axial offset per additional pin, referenced to the embodiment with two pins.

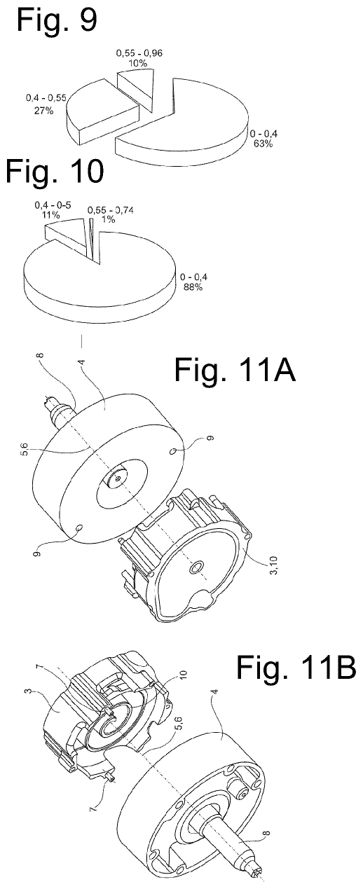

FIG. 9 shows the relative offset with two positioning elements as a quantile. For an embodiment with matched levels of rated play and tolerances of the positioning concept, it depicts, referenced to an embodiment with just one guide element, the proportion of a relative offset greater than 0.4, the proportion with offset of between 0.4 and 0,55, as well as between 0.55 and 0.96 relative to the possible offset of 1.0 for a guide element.

FIG. 10 shows the relative offset when using five positioning elements, wherein the error up to 0.4 drops to a low proportion and the proportion with a referenced relative axial offset drops to between 0.4 and 0.55. Only a very small proportion of a basic total exhibits an axis error greater than 0.55, wherein 0.74 was determined as the greatest referenced deviation. The depictions clearly demonstrate that significant improvements in average axial offset can be achieved by using five instead of two positioning elements.

Both the average axial offset of the units fitted and the maximum radial axis position errors are thereby reduced.

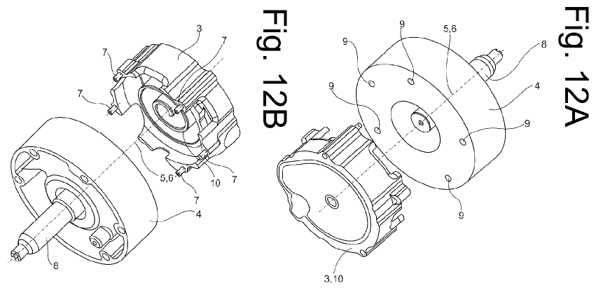

FIGS. 11A and 11B show an embodiment of a positioning arrangement with perspective views from various sides. The rotating basic component 4 with the shaft 8 shows the driven element of a scroll compressor with the pin holes 9 as per the state of the art. As depicted, the centering and basic component axes 5, 6 are ideally positioned above one another, while the centering component 3, here the orbiting scroll 10, is prepositioned in the assembly position. FIG. 11B shows the centering component 3 as an orbiting scroll 10 with the two positioning pins 7.

FIGS. 12A and 12B show, similarly to FIGS. 11A and 11B, the basic component 4 and centering component 3 as an orbiting scroll 10 with a positioning arrangement that employs five positioning pins 7 with corresponding insertion into the pin holes 9.

The use of the positioning arrangement shown for a scroll compressor is exemplary. Minimizing axial offset in the scroll compressor facilitates a significant improvement in terms of operating noise, as well as a reduction in wear to the orbiting scroll 10.

### LIST OF REFERENCE NUMBERS

1 Central cylindrical stud
2 Central cylindrical recess
3 centering component
4 Basic component
5 centering component axis
6 Basic component axis
7 Positioning pin
8 Compressor shaft
9 Pin hole(s)
10 Orbiting scroll

1-8. (canceled)

9. A positioning arrangement for positionally accurate connection of a basic component to a centering component in order to achieve axial centricity of a basic component axis and a centering component axis relative to one another, the positioning arrangement comprising:
at least three positioning pins arranged and anchored in the centering component and reaching into pin holes in the basic component, thereby forming a positive-locking connection, wherein the basic component and the centering component are connected and positioned relative to one another.

10. The positioning arrangement according to claim 9, wherein there are five of the positioning pins arranged in the centering component and there are five corresponding pin holes arranged in the basic component.

11. The positioning arrangement according to claim 9, wherein the positioning pins are arranged around the centering axis with equal spacing to the centering axis.

12. The positioning arrangement according to claim 9, wherein the positioning pins are arranged such that they are distributed equidistantly across a perimeter of a circle around the centering axis.

13. The positioning arrangement according to claim 9, wherein the positioning pins are arranged with random distribution around the centering axis.

14. The positioning arrangement according to claim 9, wherein a central cylindrical stud is also provided in the centering component and a central cylindrical recess is formed in the basic component for positioning.

15. The positioning arrangement according to claim 9, wherein the positioning pins are produced from steel and anchored in the centering component, itself produced from aluminum.

16. A scroll compressor comprising:
a fixed scroll; and
an orbiting scroll, wherein the fixed scroll includes five positioning pins arranged in the compressor housing in axial centricity with a shaft of the compressor.
